(19) United States
(12) Patent Application Publication
(10) Pub. No.: US 2009/0051557 A1
(43) Pub. Date: Feb. 26, 2009

(54) METHOD AND ELECTRICAL SWITCHING APPARATUS INCLUDING A NUMBER OF ACCESSORIES EMPLOYING WIRELESS COMMUNICATION

(76) Inventors: WILLIAM E. BEATTY, BEAVER, PA (US); SUJIT R. DAS, NEW BERLIN, WI (US); JAMES L. LAGREE, ROBINSON TOWNSHIP, PA (US); DEBORAH K. MORT, CORAOPOLIS, PA (US)

Correspondence Address: Martin J. Moran, 1000 Cherrington Parkway, Moon Township, PA, 15108, US

(21) Appl. No.: 11/841,105

(22) Filed: Aug. 20, 2007

(51) Int. Cl. H02H 3/08

(52) U.S. Cl. 340/639; 361/93.2

(57) ABSTRACT

A circuit breaker includes separable contacts, an operating mechanism opening and closing the contacts, a first processor determining an open or closed state of the contacts, and a wireless transceiver transmitting the open or closed state from the first processor and receiving a signal. A first accessory includes a wireless receiver, a second processor and outputs. A second accessory includes a wireless transmitter, a third processor and a circuit generating the signal for or communicating the signal to the third processor, which outputs the signal to the wireless transmitter, which transmits the signal to the wireless transceiver. The first processor receives the signal from the wireless transceiver and causes the mechanism to open or close the contacts. The wireless receiver receives the open or closed state from the wireless transceiver. The second processor receives the open or closed state from the wireless receiver and outputs the same to the outputs.

### BACKGROUND OF THE INVENTION

1. Field of the Invention

This invention pertains generally to electrical switching apparatus and, more particularly, to such apparatus including a number of accessories. The invention also relates to methods of communicating between a number of accessories and an electrical switching apparatus.

2. Background Information

Electrical switching apparatus, such as circuit breakers, are widely used in industrial, commercial and residential applications for protecting electrical conductors and apparatus. Circuit breakers, for example, are used to protect electrical distribution systems from damage due to an overcurrent condition, such as an overload condition or a relatively high level short circuit or fault condition. In small circuit breakers, commonly referred to as miniature circuit breakers, used for residential and light commercial applications, such protection is typically provided by a thermal-magnetic trip device. This trip device includes a bimetal, which heats and bends in response to a persistent overcurrent condition. The bimetal, in turn, unlatches a spring powered operating mechanism, which opens the separable contacts of the circuit breaker to interrupt current flow in the protected power system.

Some circuit breakers include a trip unit, which senses overcurrent conditions in an automatic mode of operation. Upon sensing an overcurrent condition, the trip unit trips the operating mechanism to a trip state, which moves the separable contacts to their open position. It is well known to employ trip units to detect various types of overcurrent trip conditions and to provide various protection functions, such as, for example, a long delay trip, a short delay trip, an instantaneous trip, and/or a ground fault trip. The earliest electronic trip unit circuit designs utilized discrete components such as transistors, resistors and capacitors. More recently, designs, such as disclosed in U.S. Pat. Nos. 4,428,022; and 5,525,985, have included microprocessors, which provide improved performance and flexibility. These digital systems sample the current waveforms periodically to generate a digital representation of the current. The microprocessor uses the samples to execute algorithms, which implement one or more current protection curves.

Electrical switching apparatus, such as circuit breakers, as well as transfer switches, network protectors and the like, are often equipped with accessories such as, for example and without limitation, auxiliary contacts, bell alarms, open/close pushbuttons, shunt trip devices, and under voltage release (UVR) devices.

Auxiliary contacts and bell alarms provide signals indicating certain conditions within the apparatus. For example, auxiliary contacts (e.g., without limitation, normally open; normally closed) of an auxiliary switch signal, for example, the open or closed state of separable contacts of the apparatus. Bell alarm contacts signal, for example, the trip state of the apparatus. These mechanical status indicating accessories are often mounted within the apparatus casings and are used by external monitoring and control equipment.

Open/close pushbuttons provide a remote mechanism to open or close the separable contacts without standing directly in front of the circuit breaker. For example, two normally open switches (one for open and the other for close) can be used for this purpose. If one and only one switch is closed, then the circuit breaker performs the corresponding requested action (open or close the circuit breaker separable contacts). If both switches are either opened or closed, then no action is taken.

Shunt trip and UVR devices can be employed in a variety of ways to initiate a change in status of the apparatus such as, for example, to trip open the separable contacts of the apparatus in response to an electrical fault condition (e.g., without limitation, current overload; short circuit; under voltage) or other external condition. The connection between the apparatus and the various accessory devices is conventionally accomplished in parallel using two wires per accessory device. The installation of these wires is costly and time consuming.

U.S. Pat. No. 6,175,780 discloses an electronic trip unit that communicates with plural remote, accessory devices over a two wire communication bus.

The installation of the above wires is both costly and time consuming.

There is, therefore, room for improvement in electrical switching apparatus and corresponding accessories.

There is also room for improvement in methods of communication between electrical switching apparatus and corresponding accessories.

### SUMMARY OF THE INVENTION

These needs and others are met by embodiments of the invention, which provide wireless communication between an electrical switching apparatus and a number of accessories thereof.

In accordance with one aspect of the invention, an electrical switching apparatus comprises: an electrical switching apparatus housing; separable contacts; an operating mechanism structured to open and close the separable contacts; a first processor cooperating with the operating mechanism to determine an open or closed state of the separable contacts; a number of accessories, each of the number of accessories comprising a wireless receiver, a second processor and a number of outputs; and a wireless transmitter structured to wirelessly transmit the open or closed state of the separable contacts from the first processor to the wireless receiver of the number of accessories, wherein the wireless receiver is structured to wirelessly receive the open or closed state of the separable contacts from the wireless transmitter, wherein the second processor is structured to receive the open or closed state of the separable contacts from the wireless receiver and to output the open or closed state of the separable contacts to the number of outputs, and wherein the number of accessories are located on or internal to the electrical switching apparatus housing.

As another aspect of the invention, an electrical switching apparatus comprises: separable contacts; an operating mechanism structured to open and close the separable contacts; a first processor cooperating with the operating mechanism to open and close the separable contacts; a wireless receiver structured to wirelessly receive a signal; and a number of accessories, each of the number of accessories comprising a wireless transmitter, a second processor and a circuit structured to generate the signal for the second processor or communicate the signal to the second processor, the second processor being structured to output the signal to the wireless transmitter, the wireless transmitter being structured to wirelessly transmit the signal to the wireless receiver, wherein the first processor is structured to receive the signal from the wireless receiver and to responsively cause the operating mechanism to open or close the separable contacts.

As another aspect of the invention, an electrical switching apparatus comprises: separable contacts; an operating mechanism structured to open and close the separable contacts; a first processor cooperating with the operating mechanism to determine an open or closed state of the separable contacts and to open and close the separable contacts; a wireless transceiver cooperating with the first processor and being structured to wirelessly transmit the open or closed state of the separable contacts from the first processor and to wirelessly receive a signal; a plurality of accessories, a first one of the accessories comprising a wireless receiver, a second processor and a number of outputs, and a second one of the accessories comprising a wireless transmitter, a third processor and a circuit structured to generate the signal for the third processor or communicate the signal to the third processor, the third processor being structured to output the signal to the wireless transmitter, the wireless transmitter being structured to wirelessly transmit the signal to the wireless transceiver, wherein the first processor is structured to receive the signal from the wireless transceiver and to responsively cause the operating mechanism to open or close the separable contacts, wherein the wireless receiver is structured to wirelessly receive the open or closed state of the separable contacts from the wireless transceiver, and wherein the second processor is structured to receive the open or closed state of the separable contacts from the wireless receiver and to output the open or closed state of the separable contacts to the number of outputs.

As another aspect of the invention, a method of wirelessly communicating between a number of accessory nodes and an electrical switching apparatus including separable contacts, comprises: wirelessly connecting the electrical switching apparatus and the number of accessory nodes to a wireless communication network; wirelessly communicating over the wireless communication network: (a) an open or closed state of the separable contacts from the electrical switching apparatus to one of the number of accessory nodes, and responsively outputting the open or closed state from the one of the number of accessory nodes, or (b) a signal from one of the number of accessory nodes to the electrical switching apparatus, and responsively opening or closing the separable contacts responsive to the signal; employing the electrical switching apparatus including an electrical switching apparatus housing; and locating the number of accessory nodes on or internal to the housing.

### BRIEF DESCRIPTION OF THE DRAWINGS

A full understanding of the invention can be gained from the following description of the preferred embodiments when read in conjunction with the accompanying drawings in which:

FIG. 1 is a block diagram of a circuit interrupter and a number of wireless accessory nodes in accordance with embodiments of the invention.

FIG. 2 is a schematic diagram in block form showing a wireless accessory communication network in accordance with embodiments of the invention.

FIGS. 3-6 are block diagrams of some of the wireless accessory nodes of FIG. 1.

FIGS. 7-9 are block diagrams of circuit breakers in accordance with other embodiments of the invention.

FIG. 10 is a schematic diagram in block form showing a wireless accessory communication network in accordance with other embodiments of the invention.

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the term “wireless” shall expressly include, but not be limited by, radio frequency (RF), light or visible light or infrared light not using optical fibers, ultrasound, wireless area networks, such as, but not limited to, IEEE 802.11 and all its variants (e.g., without limitation, 802.11a; 802.11b; 802.11g), IEEE 802.15 and all its variants (e.g., without limitation, 802.15.1; 802.15.3, 802.15.4), IEEE 802.16 and all its variants, other wireless communication standards (e.g., without limitation, ZigBee™ Alliance standard), HyperLan, DECT, PWT, pager, PCS, Wi-Fi, Bluetooth™, and cellular.

As employed herein, the term “wireless communication network” means a communication network employing wireless communications.

As employed herein, the term “network coordinator” (NC) means a communicating device, which operates as the central controller in an ad-hoc communication network or a wireless communication network.

As employed herein, the term “network device” (ND) means a communicating device, which participates in a wireless communication network, and which is not a network coordinator.

As employed herein, the term “node” includes a ND, a NC or other node, which participates in an ad-hoc communication network or a wireless communication network.

The invention is described in association with a circuit breaker, although the invention is applicable to a wide range of electrical switching apparatus.

### Example 1

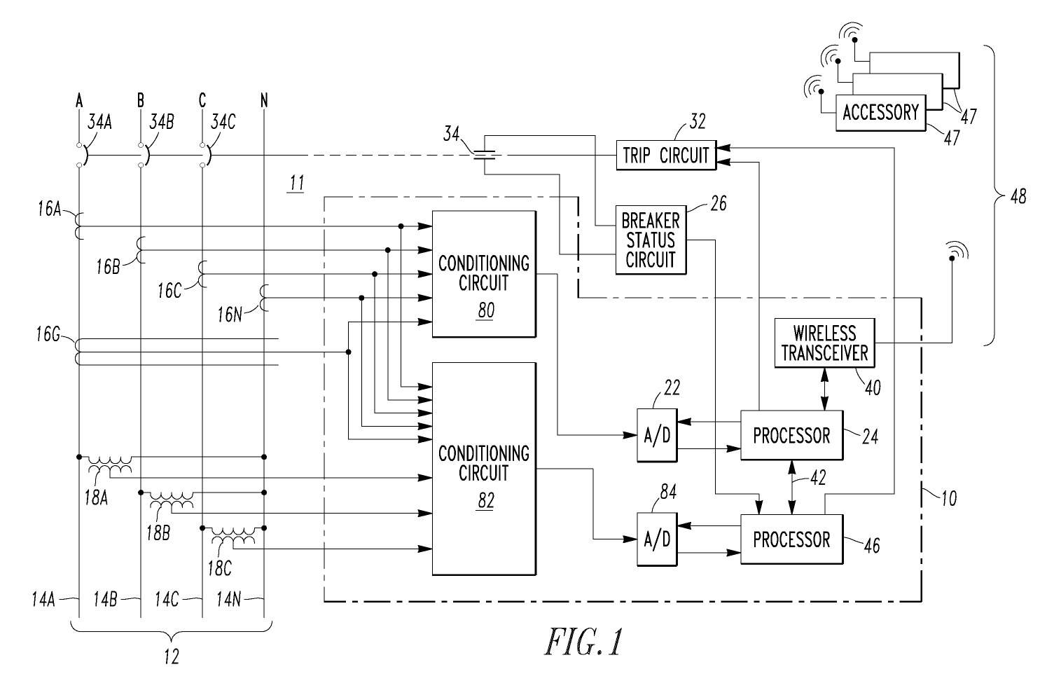

Referring to FIG. 1, an electronic trip unit 10 of a circuit interrupter, such as circuit breaker 11, protects and captures waveforms in an AC electrical power distribution system 12, which represents a load. The power distribution system 12 (e.g., without limitation, an electrical system; an AC electric power system; a power circuit) has three phase conductors 14A,14B,14C, and a neutral conductor 14N. Current transformers 16A,16B,16C,16N sense current flowing in each of these conductors. Current transformer 16G is a zero sequence transformer, which indirectly measures ground current by directly measuring the sum of the phase and neutral currents. These currents are sensed by conditioning circuits 80 and 82, which prepare the signals for processing by analog-to-digital (A/D) converters 22 and 84, respectively. Phase-to-neutral voltages are sensed from the three phase conductors 14A,14B,14C by respective potential transformers 18A,18B,18C and are inputted to conditioning circuit 82 for processing by the A/D converter 84. The conditioning circuits 80 and 82 scale the current and voltage signals to a suitable range for conversion by the A/D converters 22 and 84 for input to processors (e.g., without limitation, microcomputers) 24 and 46, respectively.

The A/D converter 84 samples analog voltages and currents, for example, at sampling instances determined by interrupts generated by the processor 46 in a manner more particularly described in U.S. Pat. No. 5,600,527, and the patents referenced therein. The processor 46 utilizes the data generated by the digital samples to provide voltage based protection functions, for example, under/over voltage protection for the electrical system 12, and also uses the samples for waveform capture and harmonic analysis for metering and display purposes.

In implementing the overcurrent protection functions, the second processor 24 operates in a protection mode to generate a trip signal when any one of the current/time characteristics of a delayed trip protection function is exceeded. This trip signal is passed to a trip mechanism, such as trip circuit 32, which opens separable contacts 34A,34B,34C in the respective three phase conductors 14A,14B,14C of the electrical system 12. The trip circuit 32 is typically a mechanically latched electronically released mechanism. Although typically not provided in the United States, additional separable contacts can be included to also interrupt current in the neutral conductor 14N. The processors 24 and 46 can also communicate with one another through, for example, a suitable serial peripheral interface (SPI) link 42.

The processor 24 provides the overcurrent protection and communicates with the trip circuit 32 to implement an overcurrent instantaneous trip requirement. The processor 46 also monitors the state of the separable contacts 34A,34B,34C or the operating mechanism (not shown) of the circuit breaker 11 through a breaker status circuit 26 to indicate the breaker's open/closed state. The processor 24 communicates through a wireless transceiver 40 (e.g., without limitation, IEEE 802.15.4; ZigBee) to a wireless communication network 48 (e.g., without limitation, IEEE 802.15.4; ZigBee).

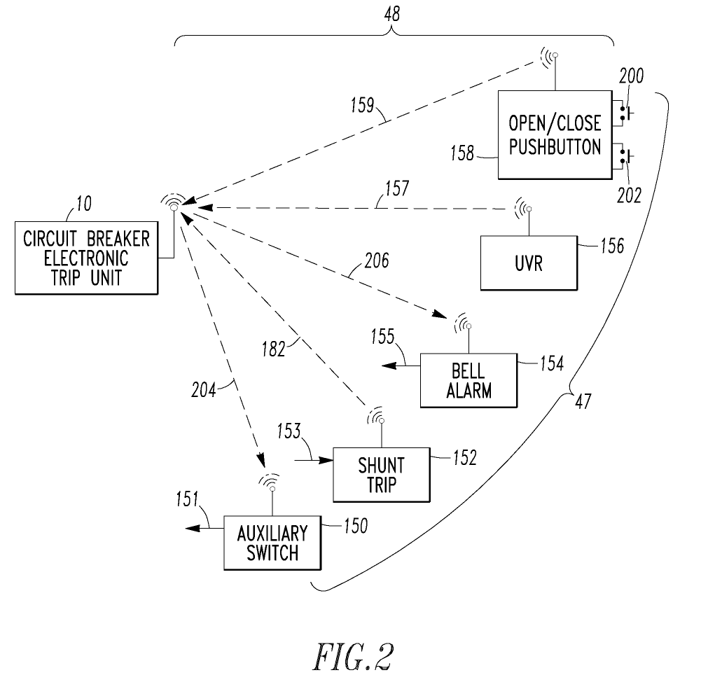

The electronic trip unit 10 advantageously employs wireless communication between (i.e., to and/or from) the trip unit 10 and a number of wireless accessories 47 (e.g., without limitation, accessory nodes) associated with that particular electronic trip unit 10 through the wireless communication network 48 that is also shown in FIG. 2. The circuit interrupter 11 and the wireless accessories 47 are, thus, wirelessly connected to the wireless communication network 48. This permits, for example, the wireless communication of the open or closed state of the separable contacts 34A,34B,34C from the circuit interrupter 11 to one of the wireless accessories 47 (e.g., auxiliary contacts; bell alarm) and responsive outputting of that open or closed state from the corresponding wireless accessory, or a signal (e.g., open; close; trip) from one of the wireless accessories 47 (e.g., shunt trip module; UVR; open/close pushbutton) to the circuit interrupter 11, which responsively opens or closes the separable contacts 34A,34B,34C responsive to that signal.

### Example 2

Referring to FIG. 7, another circuit interrupter, such as circuit breaker 100 is shown. The circuit breaker 100 includes separable contacts 102, an operating mechanism 104 structured to open and close the separable contacts, a first processor (e.g., without limitation, a microprocessor (μP)) 106 cooperating with the operating mechanism 104 to determine an open or closed state 107 of the separable contacts 102, and a number of accessories 108. Each of the accessories 108 includes a wireless receiver (RX) 110, a second processor (e.g., without limitation, a microprocessor (μP)) 112 and a number of outputs 114. The circuit breaker 100 further includes a wireless transmitter (TX) 115 structured to wirelessly transmit the open or closed state of the separable contacts 102 from the first processor 106 to the wireless receiver 110 of the accessories 108. The wireless receiver 110 is structured to wirelessly receive the open or closed state of the separable contacts 102 from the wireless transmitter 115. The second processor 112 is structured to receive the open or closed state of the separable contacts 102 from the wireless receiver 110 and to output the same to the outputs 114.

### Example 3

In this example, the circuit breaker 100 includes a circuit breaker housing 116, and a number of the accessories 108 are located on or internal to (as shown in FIG. 7) the housing 116 as opposed to being remote from a circuit breaker as is shown with the circuit breaker trip unit 10 of FIG. 2.

### Example 4

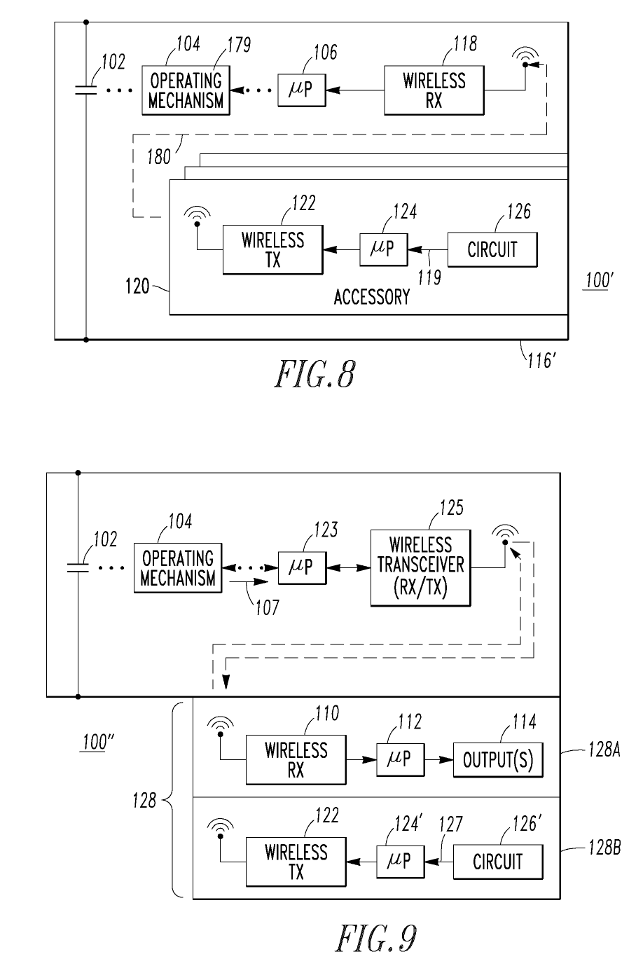

Referring to FIG. 8, another circuit interrupter, such as circuit breaker 100′, is similar to the circuit breaker 100 of FIG. 7. The circuit breaker 100′ includes the separable contacts 102, the operating mechanism 104 structured to open and close the separable contacts 102, the first processor 106 cooperating with the operating mechanism 104 to open and close the separable contacts 102, a wireless receiver (RX) 118 structured to wirelessly receive a signal 119, and a number of accessories 120. Each of the accessories 120 includes a wireless transmitter (TX) 122, a second processor (e.g., without limitation, a microprocessor (μP)) 124 and a circuit 126 structured to generate the signal 119 for the second processor 124 or communicate that signal 119 to the second processor 124. The second processor 124 is structured to output the signal 119 to the wireless transmitter 122, which, in turn, is structured to wirelessly transmit the signal 119 through wireless signal 180 to the wireless receiver 118. The first processor 106 is structured to receive the signal 119 from the wireless receiver 118 and to responsively cause the operating mechanism 104 to open or close the separable contacts 102.

### Example 5

In this example, the circuit breaker 100′ includes a circuit breaker housing 116′, and a number of the accessories 120 are located on or internal to the housing 116′.

### Example 6

Referring to FIG. 9, another circuit interrupter, such as circuit breaker 100″, is similar to the circuit breakers 100 and 100′ of FIGS. 7 and 8. The circuit breaker 100″ includes the separable contacts 102, the operating mechanism 104 structured to open and close the separable contacts 102, a first processor (e.g., without limitation, a microprocessor (μP)) 123 cooperating with the operating mechanism 104 to determine an open or closed state 107 of the separable contacts 102 and to open and close the separable contacts 102, a wireless transceiver (RX/TX) 125 cooperating with the first processor 123 and being structured to wirelessly transmit the open or closed state 107 of the separable contacts 102 from the first processor 123, and to wirelessly receive a signal 127, and a plurality of accessories 128. A first accessory 128A includes the wireless receiver 110, the second processor 112 and the number of outputs 114. A second accessory 128B includes the wireless transmitter 122, a third processor (e.g., without limitation, a microprocessor (μP)) 124′ (the second processor 124 of FIG. 8) and a circuit 126′ (the circuit 126 of FIG. 8) structured to generate the signal 127 for the third processor 124′ or communicate the signal 127 to the third processor 124′. The third processor 124′ is structured to output the signal 127 to the wireless transmitter 122, which, in turn, is structured to wirelessly transmit the signal 127 to the wireless transceiver 125. The first processor 123 is structured to receive the signal 127 from the wireless transceiver 125 and to responsively cause the operating mechanism 104 to open or close the separable contacts 102. The wireless receiver 110 is structured to wirelessly receive the open or closed state 107 of the separable contacts 102 from the wireless transceiver 125. The second processor 112 is structured to receive the open or closed state 107 of the separable contacts 102 from the wireless receiver 110 and to output the open or closed state 107 of the separable contacts 102 to the outputs 114.

### Example 7

FIG. 2 shows five examples of the wireless accessories 47 of FIG. 1. For example, wireless accessory 150 outputs an auxiliary contact 151, wireless accessory 152 inputs a shunt trip signal 153, wireless accessory 154 outputs a bell alarm 155, wireless accessory 156 generates a UVR trip signal 157, and wireless accessory 158 generates an open/close signal 159.

### Example 8

Although the wireless communication network 48 of FIGS. 1 and 2 may be any suitable wireless communication network, such a wireless communication network is preferably selected from the group consisting of an IEEE 802.15.4 wireless communication network and a ZigBee wireless communication network.

### Example 9

Although the invention is applicable to one or more wireless accessory nodes (e.g., as shown in FIGS. 7 and 8), FIG. 9 shows the wireless communication of, for example, both the open or closed state 107 of the separable contacts 102 from the circuit breaker 100″ to the first accessory 128A, which responsively outputs the open or closed state through the output(s) 114, and the signal 127 (e.g., without limitation, a shunt trip signal to trip open the separable contacts 102; a UVR trip signal to trip open such separable contacts; a pushbutton open or close signal to open or close such separable contacts) from the second accessory 128B to the circuit breaker 100″, which opens or closes the separable contacts 102 responsive to that signal.

### Example 10

As contrasted with the circuit breakers 100 of FIG. 7 and 100′ of FIG. 8, as shown with the circuit breaker trip unit 10 of FIG. 2, the number of accessory nodes 47 may be located remote from the circuit breaker.

### Example 11

Referring to FIG. 3, an accessory 160, which is suitable for use as an auxiliary switch or bell alarm, includes a wireless transceiver (RX/TX) 162, a processor 164, and a suitable output interface 166 (e.g., without limitation, a relay including one or both of normally open and normally closed contacts). In this example, when the relay is energized by the processor 164 through a suitable interface, the normally open contact is closed to energize an alarm circuit 168 (shown in phantom line drawing). Hence, the bell alarm accessory 160 is structured to annunciate the tripped open state of a corresponding circuit breaker (e.g., the circuit breaker 100 of FIG. 7).

### Example 12

Otherwise, if the accessory 160 is used as an auxiliary switch, the normally open/normally closed contacts preferably track (e.g., without limitation, the normally open contact is closed for the contacts closed state; the normally open contact is open for the contacts open state) the open or closed state of the circuit breaker separable contacts (e.g., the separable contacts 102 of FIGS. 7-9).

### Example 13

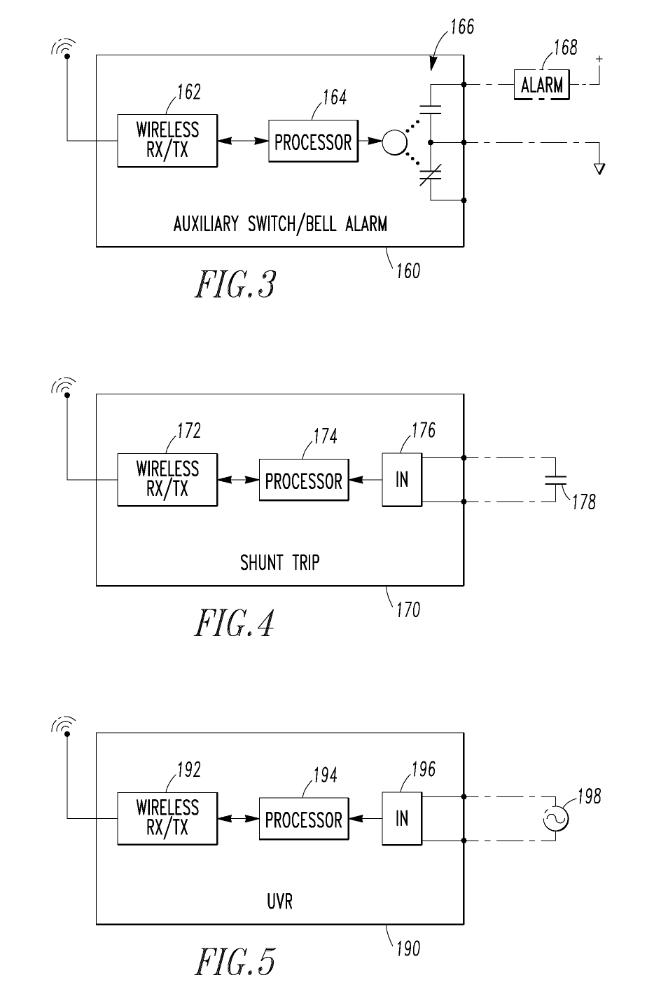

As shown in FIG. 4, a shunt trip accessory 170 includes a wireless transceiver (RX/TX) 172, a processor 174, and a suitable input interface 176 (e.g., without limitation, to an external normally open contact 178 (shown in phantom line drawing), which is closed to provide an external trip signal). In this example, a corresponding operating mechanism (e.g., 104 of FIG. 8) includes a trip mechanism 179 structured to trip open the separable contacts (e.g., 102 of FIG. 8), and the open or closed state of such separable contacts is a tripped open state.

### Example 14

Referring to FIG. 8, a wireless signal 180 from the wireless TX 122 to the wireless RX 118 is a trip signal. The accessory 120, in this example, is a shunt trip accessory, and the circuit 126 is structured to receive the trip signal 119 (e.g., without limitation, from an external contact) and to communicate the trip signal 119 to the processor 124. In turn, the processor 106 is structured to receive the trip signal from the wireless RX 118 (which may be part of a wireless transceiver (not shown)) and to responsively cause the trip mechanism 179 to trip open the separable contacts 102.

Similarly, the shunt trip accessory 152 of FIG. 2 can be used to provide a remote trip control station. For safety, it is desirable to be able to trip a circuit breaker without standing directly in front of the unit. A normally open switch (not shown) feeds the shunt trip signal 153 for this purpose. In turn, the electronic trip unit 10 reads this switch through the wireless signal 182 of FIG. 2, such that if the switch is closed, then the circuit breaker trip unit 10 performs the requested trip action. Such a request may, for example, be confirmed by multiple reads to avoid false action.

### Example 15

As shown in FIG. 5, a UVR trip accessory 190 includes a wireless transceiver (RX/TX) 192, a processor 194, and a suitable input interface 196 (e.g., without limitation, to an alternating current (AC) voltage source 198 (shown in phantom line drawing), which provides the line voltage to a corresponding circuit breaker, such as the circuit breaker 100′ of FIG. 8). In this example, the corresponding operating mechanism (e.g., 104 of FIG. 8) includes the trip mechanism 179 structured to trip open the separable contacts (e.g., 102 of FIG. 8), and the open or closed state of such separable contacts is the tripped open state. The wireless signal 180 from the wireless TX 122 to the wireless RX 118 is the trip signal. The accessory 120 (FIG. 8), in this example, is a UVR trip accessory, and the circuit 126 is structured to detect an under voltage condition of the AC voltage source 198 (FIG. 5) and responsively generate the trip signal 119 for the processor 124. The processor 106 is structured to receive the trip signal 119 from the wireless RX 118 (which may be part of a wireless transceiver (not shown)) and to responsively cause the trip mechanism 179 to trip open the separable contacts 102.

### Example 16

As shown in FIG. 2, the open/close signal 159 of the open/close pushbutton accessory 158 may be either an open signal or a close signal from one of the two pushbuttons 200,202. Here, the circuit 126 of FIG. 8 is structured to detect an open request or a close request 119 and responsively generate the open signal or the close signal for the processor 124. The processor 106 is structured to receive the open signal or the close signal from the wireless receiver 118 (which may be part of a wireless transceiver (not shown)) and to responsively cause the operating mechanism 104 to open or close, respectively, the separable contacts 102.

### Example 17

The electronic trip unit 10 of FIG. 2 may function as the master and the wireless accessory nodes 47 may function as slaves. The electronic trip unit 10 may serve as the bus “master” node of the wireless communication network 48 that controls remote “slave” nodes such of the wireless communication network, which slave nodes are the various wireless accessory nodes 150, 152, 154, 156 and 158. The information to and from the remote wireless accessory nodes 47 from and to the master trip unit 10 is carried by wireless messages, such as 157,159,182,204,206 rather than by wires or a wired bus.

### Example 18

As an alternative to Example 17, a peer-to-peer structure may be employed. In this example, the electronic trip unit 10 and the various wireless accessory nodes 150, 152, 154, 156 and 158 are peer nodes of the wireless communication network 48.

### Example 19

The wireless messages, such as 157,159,182,204,206, preferably convey the information to and from the remote wireless accessory nodes 47 from and to the master trip unit 10 as fast as possible.

### Example 20

In Example 17, the master node 10 may employ, for example, one message type (e.g., 204;206) to send a digital output (e.g., an auxiliary switch signal; a bell alarm signal) to one of the slave nodes 47 and another message type (e.g., 157;159;182) to request a digital input (e.g., a shunt trip signal; a UVR trip signal; an open signal; a close signal) from one of the slave nodes 47 for the master/slave approach.

### Example 21

In the peer-to-peer approach of Example 18, the various nodes 10,47 preferably employ messages that indicate that the sending node has some thing for the receiving node, in order to preferably wirelessly communicate the information between the respective wirelessly communicating nodes in the quickest manner possible.

### Example 22

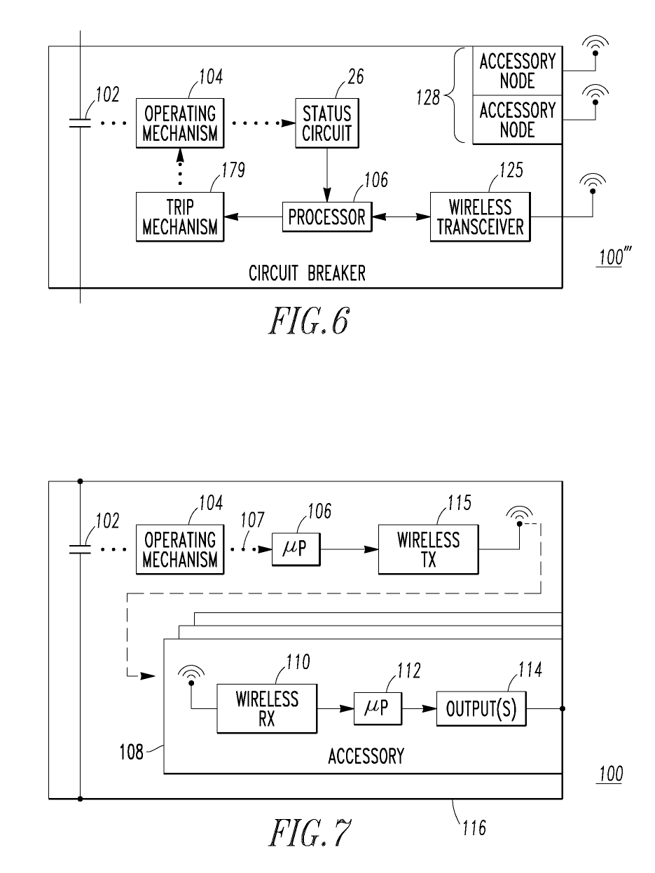

FIG. 6 shows another circuit breaker 100′″, which is similar to the circuit breaker 100″ of FIG. 9. Here, the processor 106 includes the status circuit 26 of FIG. 1 to determine the open or close state of the separable contacts 102 from the operating mechanism 104.

### Example 23

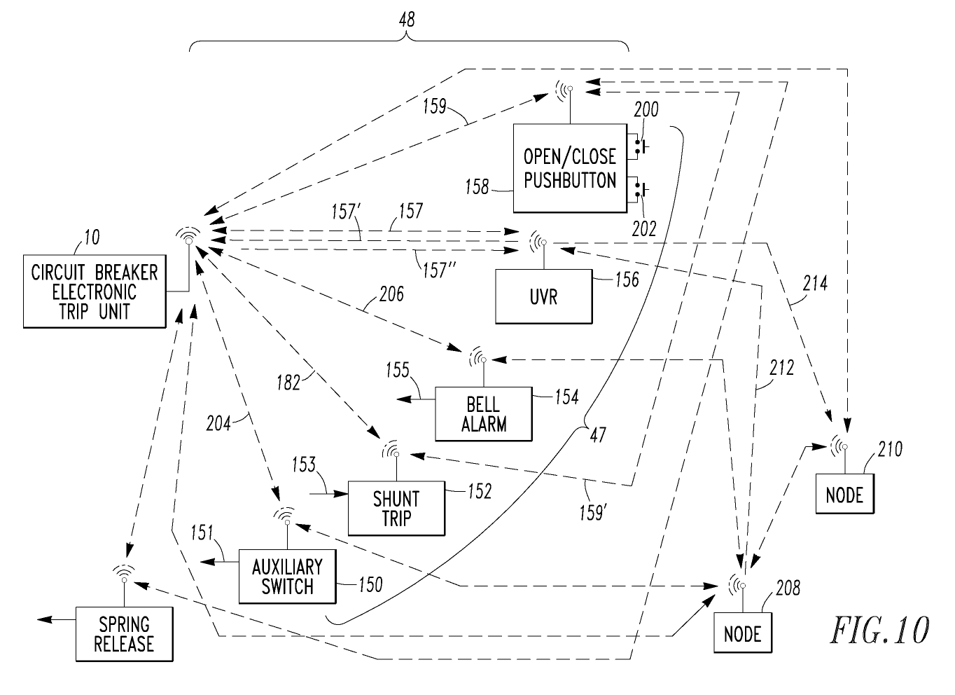

Referring to FIG. 10, one advantage of an example ZigBee™ wireless communication network is its meshing capability in which it is set up as a “peer-to-peer” communication system (as in, for example, Example 18, above). For example, instead of employing a master node, a remote pushbutton wireless node, such as 158, could actuate a shunt trip wireless node, such as 152, through signal 159′ without the requirement for the circuit breaker electronic trip unit 10 to know about it. Preferably, however, the trip unit 10 knows the source of its input(s). Here, also, additional nodes, such as 208,210, wirelessly communicate (directly and/or indirectly) with the trip unit 10 and/or with one, some or all of the wireless accessories 47, such as shown with UVR 156. In addition, some or all of the wireless accessories 47 may communicate with other ones of the wireless accessories 47, such as shown with the nodes 152,158.

### Example 24

In this example, the wireless signal 212 from the node 208 to the UVR 156 is relayed to the trip unit 10 as signal 157′ by the UVR 156. Also, the signal 157″ from the trip unit 10 to the UVR 156 is relayed to the node 210 as signal 214 by the UVR 156.

### Example 25

Although separable contacts 34A,34B,34C,102 are disclosed, suitable solid state separable contacts may be employed. For example, the disclosed circuit breakers 100,100′,100″, 100′″ include a suitable circuit interrupter mechanism, such as the separable contacts 102 that are opened and closed by the operating mechanism 104, although the invention is applicable to a wide range of circuit interruption mechanisms (e.g., without limitation, solid state or FET switches; contactor contacts) and/or solid state based control/protection devices (e.g., without limitation, drives; soft-starters).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. An electrical switching apparatus comprising:
an electrical switching apparatus housing;
separable contacts;
an operating mechanism structured to open and close said separable contacts;
a first processor cooperating with said operating mechanism to determine an open or closed state of said separable contacts;
a number of accessories, each of said number of accessories comprising a wireless receiver, a second processor and a number of outputs; and
a wireless transmitter structured to wirelessly transmit the open or closed state of said separable contacts from said first processor to said wireless receiver of said number of accessories,
wherein said wireless receiver is structured to wirelessly receive the open or closed state of said separable contacts from said wireless transmitter,
wherein said second processor is structured to receive the open or closed state of said separable contacts from said wireless receiver and to output the open or closed state of said separable contacts to said number of outputs, and
wherein said number of accessories are located on or internal to said electrical switching apparatus housing.

2. The electrical switching apparatus of claim 1 wherein one of said number of accessories is an auxiliary switch accessory; and wherein said number of outputs is a number of contacts structured to output the open or closed state of said separable contacts.

3. The electrical switching apparatus of claim 1 wherein said operating mechanism comprises a trip mechanism structured to trip open said separable contacts; wherein the open or closed state of said separable contacts is a tripped open state; and wherein one of said number of accessories is a bell alarm accessory structured to annunciate said tripped open state.

4. An electrical switching apparatus comprising:
separable contacts;
an operating mechanism structured to open and close said separable contacts;
a first processor cooperating with said operating mechanism to open and close said separable contacts;
a wireless receiver structured to wirelessly receive a signal; and
a number of accessories, each of said number of accessories comprising a wireless transmitter, a second processor and a circuit structured to generate the signal for said second processor or communicate the signal to said second processor, said second processor being structured to output the signal to said wireless transmitter, said wireless transmitter being structured to wirelessly transmit the signal to said wireless receiver,
wherein said first processor is structured to receive the signal from said wireless receiver and to responsively cause said operating mechanism to open or close said separable contacts.

5. The electrical switching apparatus of claim 4 wherein said operating mechanism comprises a trip mechanism structured to trip open said separable contacts; wherein said signal is a trip signal; wherein one of said number of accessories is a shunt trip accessory; wherein said circuit is structured to receive said trip signal and to communicate said trip signal to said second processor; and wherein said first processor is structured to receive the trip signal from said wireless receiver and to responsively cause said trip mechanism to trip open said separable contacts.

6. The electrical switching apparatus of claim 4 wherein said operating mechanism comprises a trip mechanism structured to trip open said separable contacts; wherein said signal is a trip signal; wherein one of said number of accessories is an under voltage release accessory; wherein said circuit is structured to detect an under voltage condition and responsively generate the trip signal for said second processor; and wherein said first processor is structured to receive the trip signal from said wireless receiver and to responsively cause said trip mechanism to trip open said separable contacts.

7. The electrical switching apparatus of claim 4 wherein said signal is an open signal or a close signal; wherein one of said number of accessories is an open/close pushbutton accessory; wherein said circuit is structured to detect an open request or a close request and responsively generate the open signal or the close signal for said second processor; and wherein said first processor is structured to receive the open signal or the close signal from said wireless receiver and to responsively cause said operating mechanism to open or close, respectively, said separable contacts.

8. An electrical switching apparatus comprising:
separable contacts;
an operating mechanism structured to open and close said separable contacts;
a first processor cooperating with said operating mechanism to determine an open or closed state of said separable contacts and to open and close said separable contacts;
a wireless transceiver cooperating with said first processor and being structured to wirelessly transmit the open or closed state of said separable contacts from said first processor, and to wirelessly receive a signal;
a plurality of accessories, a first one of said accessories comprising a wireless receiver, a second processor and a number of outputs, and a second one of said accessories comprising a wireless transmitter, a third processor and a circuit structured to generate the signal for said third processor or communicate the signal to said third processor, said third processor being structured to output the signal to said wireless transmitter, said wireless transmitter being structured to wirelessly transmit the signal to said wireless transceiver,
wherein said first processor is structured to receive the signal from said wireless transceiver and to responsively cause said operating mechanism to open or close said separable contacts,
wherein said wireless receiver is structured to wirelessly receive the open or closed state of said separable contacts from said wireless transceiver, and
wherein said second processor is structured to receive the open or closed state of said separable contacts from said wireless receiver and to output the open or closed state of said separable contacts to said number of outputs.

9. The electrical switching apparatus of claim 8 wherein the first one of said accessories is an auxiliary switch accessory; and wherein said number of outputs is a number of contacts structured to output the open or closed state of said separable contacts.

10. The electrical switching apparatus of claim 8 wherein the open or closed state of said separable contacts is a tripped open state; and wherein the first one of said accessories is a bell alarm accessory structured to annunciate said tripped open state.

11. The electrical switching apparatus of claim 8 wherein said operating mechanism comprises a trip mechanism structured to trip open said separable contacts; wherein said signal is a trip signal; wherein the second one of said accessories is a shunt trip accessory; wherein said circuit is structured to receive said trip signal and to communicate said trip signal to said third processor; and wherein said first processor is structured to receive the trip signal from said wireless transceiver and to responsively cause said trip mechanism to trip open said separable contacts.

12. The electrical switching apparatus of claim 8 wherein said operating mechanism comprises a trip mechanism structured to trip open said separable contacts; wherein said signal is a trip signal; wherein the second one of said accessories is an under voltage release accessory; wherein said circuit is structured to detect an under voltage condition and responsively generate the trip signal for said third processor; and wherein said first processor is structured to receive the trip signal from said wireless transceiver and to responsively cause said trip mechanism to trip open said separable contacts.

13. The electrical switching apparatus of claim 8 wherein said signal is an open signal or a close signal; wherein the second one of said accessories is an open/close pushbutton accessory; wherein said circuit is structured to detect an open request or a close request and responsively generate the open signal or the close signal for said third processor; and wherein said first processor is structured to receive the open signal or the close signal from said wireless transceiver and to responsively cause said operating mechanism to open or close, respectively, said separable contacts.

14. A method of wirelessly communicating between a number of accessory nodes and an electrical switching apparatus including separable contacts, said method comprising:
wirelessly connecting said electrical switching apparatus and said number of accessory nodes to a wireless communication network;
wirelessly communicating over said wireless communication network:
(a) an open or closed state of the separable contacts from said electrical switching apparatus to one of said number of accessory nodes, and responsively outputting said open or closed state from said one of said number of accessory nodes, or
(b) a signal from one of said number of accessory nodes to said electrical switching apparatus, and responsively opening or closing the separable contacts responsive to said signal;
employing said electrical switching apparatus including an electrical switching apparatus housing; and
locating said accessory nodes on or internal to said electrical switching apparatus housing.

15. The method of claim 14 further comprising
selecting said wireless communication network from the group consisting of an IEEE 802.15.4 wireless communication network and a ZigBee wireless communication network.

16. The method of claim 14 further comprising
employing as said number of accessory nodes a plurality of accessory nodes;
wirelessly communicating over said wireless communication network the open or closed state of the separable contacts from said electrical switching apparatus to a first one of said accessory nodes, and responsively outputting said open or closed state from said first one of said accessory nodes; and
wirelessly communicating over said wireless communication network the signal from a second one of said accessory nodes to said electrical switching apparatus, and responsively opening or closing the separable contacts responsive to said signal.

17. The method of claim 16 further comprising
employing said electrical switching apparatus as a master node of said wireless communication network; and
employing said accessory nodes as slave nodes of said wireless communication network.

18. The method of claim 17 further comprising
wirelessly communicating a first wireless message type over said wireless communication network including the open or closed state of the separable contacts from said electrical switching apparatus to the first one of said accessory nodes; and
wirelessly communicating a different second wireless message type over said wireless communication network to request the signal from the second one of said accessory nodes to said electrical switching apparatus.

19. The method of claim 16 further comprising
employing said electrical switching apparatus and said accessory nodes as peer nodes of said wireless communication network.

20. The method of claim 19 further comprising
wirelessly communicating a wireless message over said wireless communication network including the open or closed state of the separable contacts from said electrical switching apparatus to the first one of said accessory nodes; and
wirelessly communicating another wireless message over said wireless communication network including the signal from the second one of said accessory nodes to said electrical switching apparatus.

21. The method of claim 14 further comprising
wirelessly communicating another wireless signal over said wireless communication network as: (a) a wireless signal between one of said accessory nodes and another one of said accessory nodes; or (b) a signal between one of said accessory nodes and another node other than said accessory nodes and said electrical switching apparatus.
